(19) United States
(12) Patent Application Publication
(10) Pub. No.: US 2007/0083927 A1
(43) Pub. Date: Apr. 12, 2007

(54) Method and system for managing denial of services (DoS) attacks

(75) Inventor: Ashish Swaroop, Bangalore (IN)

Correspondence Address: Evalueserve;c/o PortfolioIP, P.O. Box 52050, Minneapolis, MN, 55402, US

(73) Assignee: INTEL CORPORATION, SANTA CLARA, CA (US)

(21) Appl. No.: 11/247,127

(22) Filed: Oct. 11, 2005

(51) Int. Cl. G06F 12/14

(52) U.S. Cl. 726/22

(57) ABSTRACT

Various embodiments of the invention relate to methods and systems for managing Denial of Service (DoS) attacks in a network. In various embodiments of the invention, the system identifies logical communication states that are under a DoS attack. The identification is based on the number of communications in the logical communication states. The number of communications is compared to a first set of threshold values. Further, one or more suspected attackers are detected in the logical communication states that are identified as being under the DoS attack. In accordance with various embodiments of the invention, countermeasures are initiated against the DoS attack from one or more suspected attackers, when the number of communications in the logical communication states is more than a second set of threshold values.

### BACKGROUND

Embodiments of the invention generally relate to the field of computer networks. In particular, the embodiments of the invention relate to a method and a system for managing Denial of Service (DoS) attacks in a network.

Computer networks use several telephony, internetworking, and audiovisual protocols, such as TCP/IP, SIP, H.323, and the like, for transmission of data packets. The increase in the use of and reliance on computer networks, in particular the Internet, for business and personal communications, commercial transactions, distribution and collection of information, has resulted in increased vulnerability to damage caused by network attacks. This weakness is exploited at various network devices, such as at a gateway, a switch, a server, a router, and the like.

Malicious programs may misappropriate the resources or processing power of various network devices, denying various services being provided by the network devices. The denial of services by the network devices indicates attacks, generally known as DoS attacks, which may crash the network or some of the network devices to which the users are trying to connect. DoS attacks may be of various types, such as Distributed Denial of Service (DDOS) attacks, SYN attacks, ping attacks, ping of flood attacks, teardrop attacks, DoS attacks in packet based networks, DoS attacks in Voice over Internet Protocol (VoIP), and the like.

In the present state of the technology, various methods are available for detecting and preventing DoS attacks in a network, in which the sources of DoS attacks are traced before any action is taken against the attacks. Each data packet is scanned during transmission and information related to it is stored, in order to detect the DoS attacks. This results in increased usage of memory for storing information related to each packet. Further, many methods monitor the network, even in the absence of a DoS attack. This increases the usage of the processing power of network devices for tracing the DoS attacks.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram illustrating an exemplary operational environment of various embodiments of the invention;

FIG. 2 is a block diagram illustrating modules implemented in a gateway, to manage DoS attacks, in accordance with various embodiments of the invention;

FIG. 3 is a block diagram illustrating functional modules of a detection module, in accordance with various embodiments of the invention;

FIG. 4 is a block diagram illustrating functional modules of a countermeasures module, in accordance with various embodiments of the invention;

FIG. 5 illustrates a flowchart of a method for managing a Denial of Service (DoS) attack, in accordance with various embodiments of the invention;

FIG. 6 illustrates a flowchart of a method for identifying one or more states under a DoS attack, in accordance with various embodiments of the invention;

FIG. 7 is an exemplary graph depicting a DoS attack in a disconnecting state, in accordance with various embodiments of the invention;

FIG. 8 is an exemplary graph depicting a DoS attack in a connecting state, in accordance with various embodiments of the invention;

FIG. 9 is an exemplary graph depicting a DoS attack in a connected state, in accordance with various embodiments of the invention;

FIG. 10 illustrates a flowchart of a method for detecting suspected attackers in the disconnecting state, in accordance with various embodiments of the invention;

FIG. 11 illustrates a flowchart of a method for detecting suspected attackers in the connecting state, in accordance with various embodiments of the invention;

FIG. 12 illustrates a flowchart of a method for detecting suspected attackers in the connected state, in accordance with various embodiments of the invention;

FIG. 13 illustrates a flowchart of a method for initiating countermeasures against the DoS attack, in accordance with various embodiments of the invention;

FIG. 14 illustrates a flowchart of a method for preventing a DoS attack from suspected attackers, in accordance with various embodiments of the invention;

FIG.15 shows an exemplary Terminal Capability Set (TCS) message transfer, in accordance with various embodiments of the invention;

FIG. 16 illustrates a flowchart of a method for detecting a DoS attack caused by TCS messages, in accordance with an exemplary embodiment of the invention;

FIG. 17 is a block diagram depicting an exemplary master and slave configuration, in accordance with various embodiments of the invention;

FIG. 18 illustrates a flowchart of a method for detecting a DoS attack caused by Master and Slave Determination (MSD) messages, in accordance with an exemplary embodiment of the invention;

FIG.19 shows an exemplary Open and Close Logical Channels (OLC/CLC) sequence message transfer, in accordance with various embodiments of the invention; and

FIG. 20 illustrates a flowchart of a method for detecting a DoS attack caused by OLC/CLC messages, in accordance an exemplary embodiment of the invention.

### DESCRIPTION OF PREFERRED EMBODIMENTS

Various embodiments of the invention provide a method and a system for managing Denial of Service (DoS) attacks in a network. The system identifies a DoS attack in the network, based on the number of communications in the network. The system monitors the DoS attack if a first set of threshold values of a number of communications is reached. The system also initiates countermeasures against the DoS attack when a second set of threshold values of a number of communications is reached.

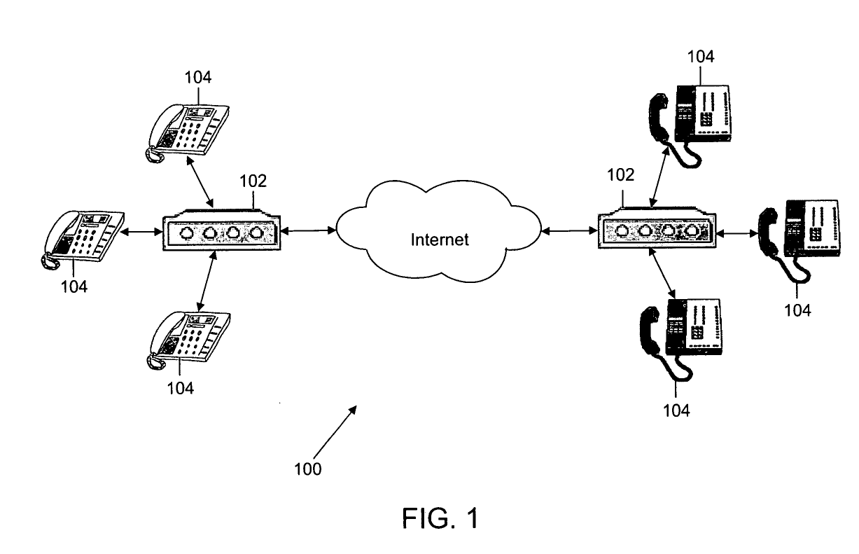

FIG. 1 is a block diagram illustrating an exemplary operational environment of various embodiments of the invention. The exemplary operational environment includes a network 100. Network 100 includes a plurality of gateways 102, hereinafter referred to as gateway 102, and a plurality of end points 104, hereinafter referred to as end points 104. Gateway 102 interlinks end points 104 to various devices in network 100. Network 100 provides a platform for data storage and data transmission between various network devices, for example, between gateway 102 and end points 104.

In various embodiments of the invention, network 100 may be a wired or wireless network, such as a Local Area Network (LAN), a Wide Area Network (WAN), the Internet, and the like. Several telephony, internetworking, and audiovisual protocols, such as H.323 protocol, Session Initiation Protocol (SIP), and Transmission Control Protocol/Internet Protocol (TCP/IP) may be used by network 100 for data transfer in various forms. H.323 is a protocol approved by the International Telecommunication Union (ITU) in 1996, to promote compatibility in videoconference transmissions over Voice over Internet Protocol (VOIP) networks. SIP is a signalling protocol for Internet conferencing and telephony over VolP, multimedia distribution, multimedia conferences, events notification and instant messaging. SIP is an Internet Engineering Task Force (IETF) standard protocol and was developed within the IETF MMUSIC (Multiparty Multimedia Session Control) working group, with work proceeding since September 1999. TCP/IP is a suite of protocols used to manage network communications and applications over the Internet. TCP/IP forms the basis for transmitting and routing data packets on the Internet.

Gateway 102 provides translation and management of communication between various network devices in network 100. Gateway 102 carries out communications in one or more logical communication states. The logical communication states are characterized by a set of message transfers. In the case of VolP and TCP/IP, there may be three logical communication states, i.e., the connecting, connected and disconnecting states. In various embodiments of the invention, the number of logical communication states, hereinafter referred to as states, may vary based on the logic used to differentiate them.

Network 100 may be attacked in one or more states by various types of DoS attacks, such as a Distributed Denial of Service attack (DDoS), a SYN attack, a ping attack, a ping of death attack, a FIN attack, a teardrop attack, and the like. In various embodiments of the invention, the different types of DoS attacks are managed by gateway 102.

In various embodiments of the invention, gateway 102 is said to be in a normal mode when the number of communications in one or more states is below a first set of threshold values. In various embodiments of the invention, a DoS attack is identified on gateway 102, when the number of communications in one or more states exceeds the first set of threshold values. This results in gateway 102 entering a conservative mode. Further, when the number of communications in one or more states exceeds the second set of threshold values, gateway 102 enters a panic mode and thereafter takes countermeasures against the DoS attack.

In various embodiments of the invention, gateway 102 may include a VolP gateway, a VolP server, a Private Branch Exchange (PBX), an Extended Private Automatic Branch Exchange (EPABX), a Host Media Processing (HMP) software, an IPlink board in the Modular Communication Platform Division (MCPD), a SIP gateway, a router, a boundary gateway for TCP/IP, a bridge, a switch, and the like.

In various embodiments of the invention, end points 104 include telephones, workstations, desktop computers, laptops, and the like.

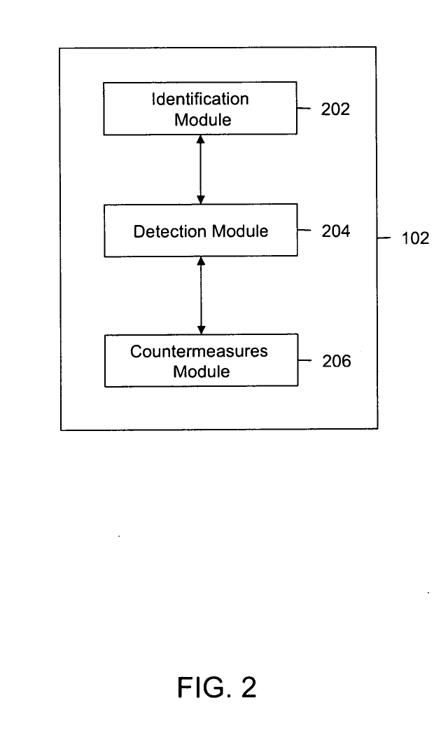

FIG. 2 is a block diagram illustrating modules implemented in gateway 102, to manage DoS attacks, in accordance with various embodiments of the invention. Gateway 102 includes an identification module 202, a detection module 204, and a countermeasures module 206. Identification module 202 identifies a DoS attack on gateway 102. Detection module 204 detects suspected attackers relating to the identified DoS attack. Further, countermeasures module 206 initiates countermeasures against the suspected attackers.

Identification module 202 identifies a DoS attack on gateway 102 when the first set of threshold values is reached. Further, identification module 202 identifies one or more states that are under the DoS attack. After the DoS attack has been identified, gateway 102 enters the conservative mode from the normal mode.

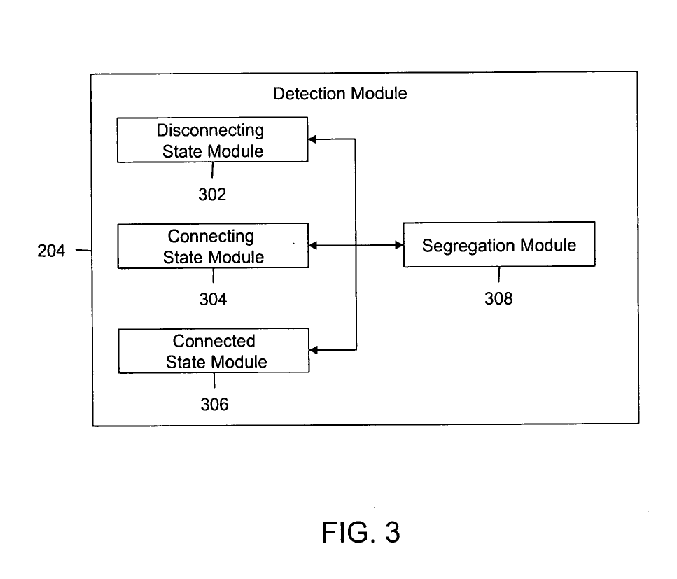

In the conservative mode, detection module 204 detects suspected attackers in the state identified as being under a DoS attack. In various embodiments of the invention, detection module 204 detects the suspected attackers, based on protocol/control message transfers, data transfers, and the time during which communications remain in the state identified as being under a DoS attack. Various functional modules of detection module 204 are described in conjunction with FIG. 3.

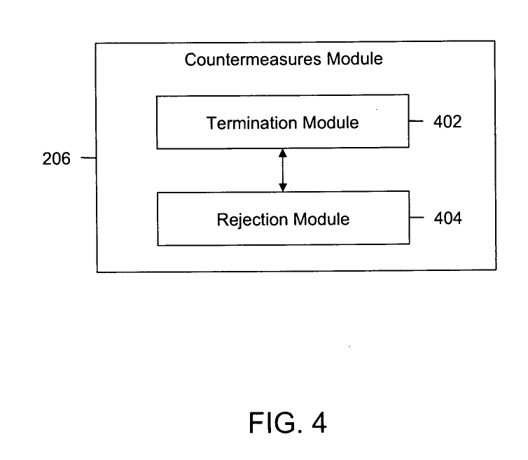

Countermeasures module 206 initiates countermeasures against the suspected attackers when the second set of threshold values is reached. This results in gateway 102 entering the panic mode from the conservative mode. The various functional modules of countermeasures module 206 are described in conjunction with FIG. 4.

FIG. 3 is a block diagram illustrating the functional modules of detection module 204, in accordance with various embodiments of the invention. Detection module 204 includes a disconnecting state module 302, a connecting state module 304, a connected state module 306, and a segregation module 308. Disconnecting state module 302 detects suspected attackers in the disconnecting state when the DoS attack is identified in the disconnecting state. Similarly, connecting state module 304 and connected state module 306 detect the suspected attackers in the connecting and the connected state, respectively. Further, segregation module 308 segregates suspected attacks from meaningful communications in the state under the DoS attack.

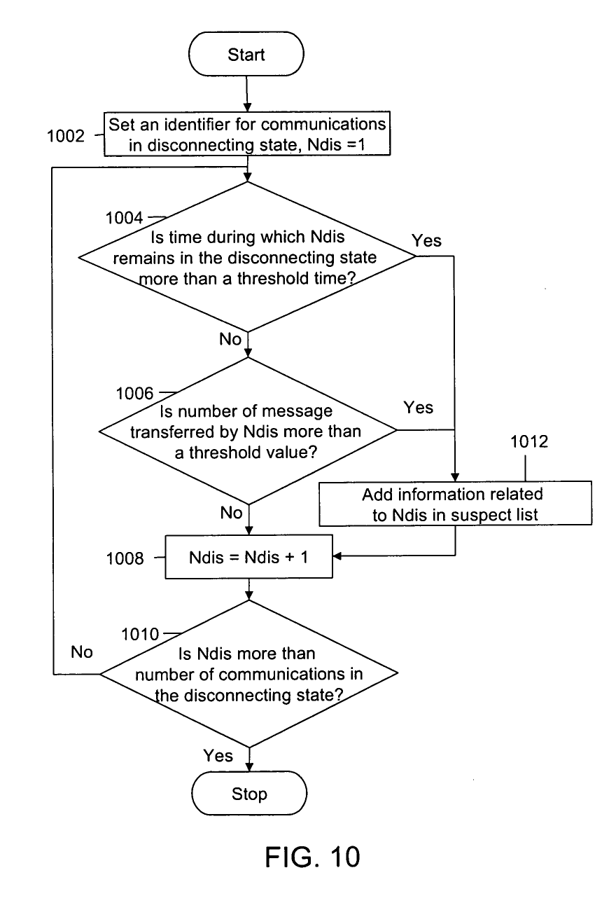

In one embodiment of the invention, disconnecting state module 302 detects the suspected attackers, based on the time during which one or more communications remain in the disconnecting state. Further, disconnecting state module 302 detects the suspected attackers, based on the number of protocol/control message transfers in one or more communications between one or more end points 104 in the disconnecting state. Further details about the functioning of disconnecting state module 302 are provided in conjunction with FIG. 10.

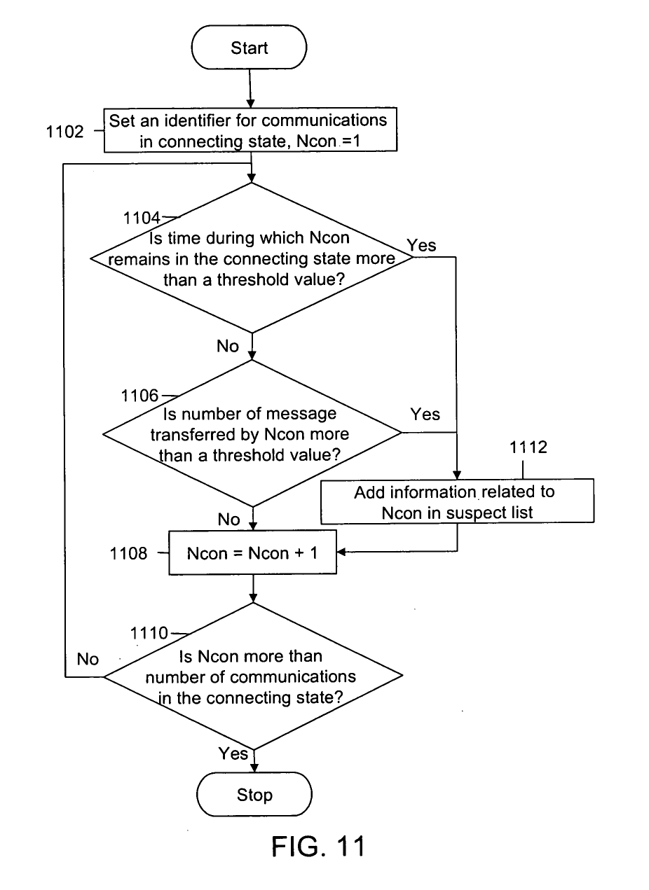

In one embodiment of the invention, connecting state module 304 detects the suspected attackers, based on the time during which one or more communications remain in the connecting state. Further, connecting state module 304 detects the suspected attackers, based on the number of protocol/control message transfers in one or more communications between end points 104 in the connecting state. Further details about the functioning of connecting state module 304 are provided in conjunction with FIG. 11.

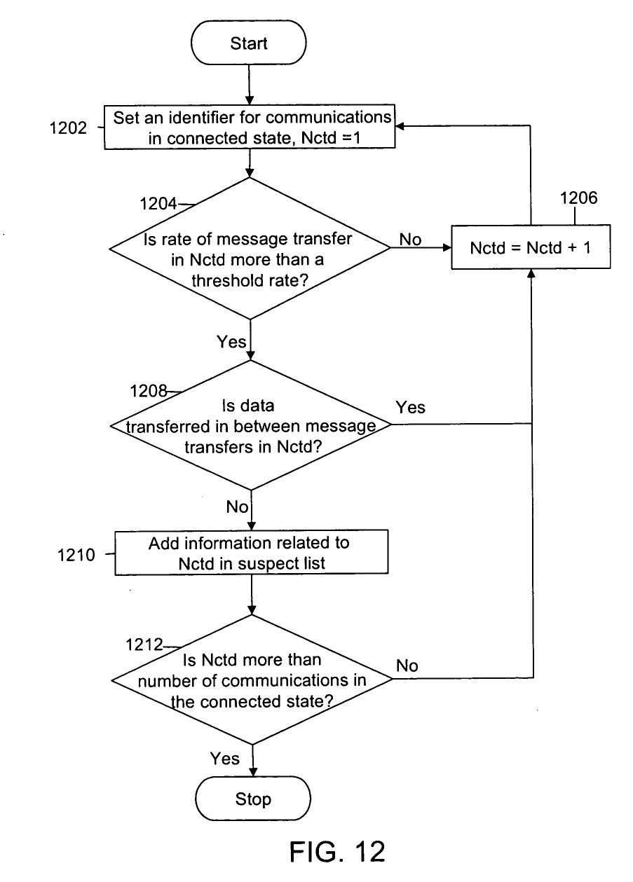

In one embodiment of the invention, connected state module 306 detects the suspected attackers, based on the rate of protocol/control message transfers. Further, connected state module 306 detects the suspected attackers, based on the data transferred between various protocol/control message transfers. In the case of VolP, the protocol/control messages being transferred include Terminal Capability Set (TCS) messages, Master Slave Determination (MSD) messages, Open and Close Logical Channel (OLC/CLC) sequence messages, and the like. Further details about the functioning of connected state module 306 are provided in conjunction with FIG. 12.

Segregation module 308 segregates suspected attacks from meaningful communications in the states under a DoS attack. Further, segregation module 308 maintains the information pertaining to suspected attacks in a suspect list. In one embodiment of the invention, information pertaining to meaningful communications is maintained in a good list. In various embodiments of the invention, the information pertaining to suspected attacks includes source packet addresses, such as IP addresses, of the suspected attackers.

FIG. 4 is a block diagram illustrating the functional modules of countermeasures module 206, in accordance with various embodiments of the invention. Countermeasures module 206 includes a termination module 402 and a rejection module 404. In various embodiments of the invention, countermeasures module 206 operates in the panic mode. Termination module 402 terminates existing communications in one or more states. Rejection module 404 rejects future requests for communication from the suspected attackers.

In various embodiments of the invention, termination module 402 terminates communications from the suspected attackers, first in the disconnecting state, then in the connecting state, and after that in the connected state. In one embodiment of the invention, communications may only be terminated in the states that are identified as being under the DoS attack.

Rejection module 404 maintains a suspect list of suspected attackers that were responsible for causing previous DoS attacks on gateway 102. Thereafter, rejection module 404 rejects future requests for communication from these suspected attackers. In one embodiment of the invention, rejection module 404 rejects future requests for communications from these suspected attackers when gateway 102 is in the panic mode. In one embodiment of the invention, the suspect list may be periodically updated, which takes into account changes in suspected attackers over time.

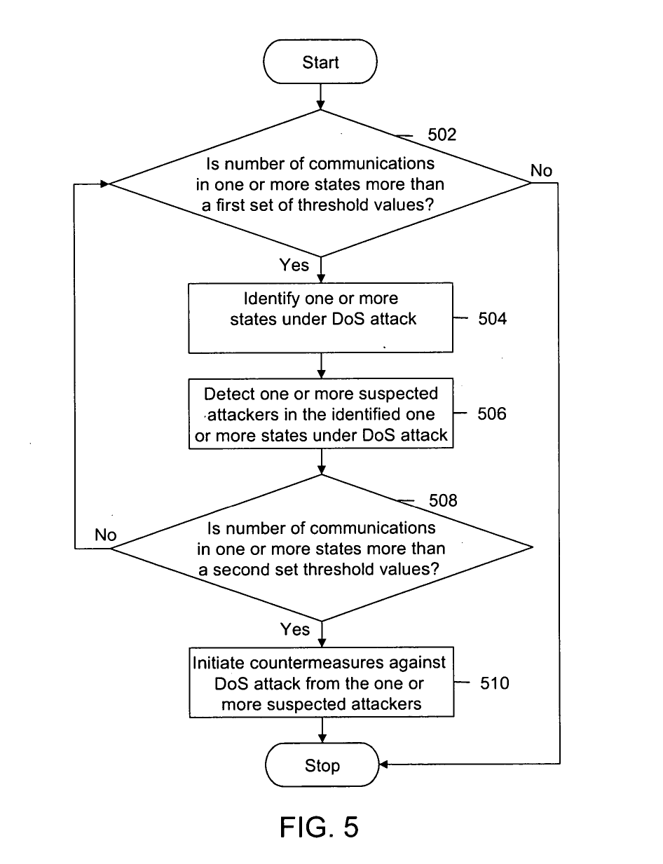

FIG. 5 illustrates a flowchart of a method for managing a DoS attack, in accordance with various embodiments of the invention. At 502, it is checked whether the number of communications in one or more states is more than a first set of threshold values. This check is performed to identify a DoS attack in one or more states. In various embodiments of the invention, the first set of threshold values includes the first threshold values of the number of communications, Tconₜₕ₁, Tctdₜₕ₁ and Tdisₜₕ₁, in the connecting, connected and disconnecting states, respectively. Further, the first set of threshold values includes a first threshold value of the cumulative number of communications in the three states, Tcurrₜₕ₁. In one embodiment of the invention, the cumulative number of communications in the three states, Tcurr, is first compared with Tcurrₜₕ₁. In an alternate embodiment of the invention, the number of communications in the connecting, connected, and disconnecting states is compared with the respective first threshold values, i.e., Tconₜₕ₁, Tctdₜₕ₁ and Tdisₜₕ₁. In various embodiments of the invention, when a DoS attack is identified at 502, gateway 102 enters the conservative mode from the normal mode. Otherwise, gateway 102 remains in the normal mode. In the normal mode, 502 is repeated periodically, to compare the number of communications in one or more states with the first set of threshold values.

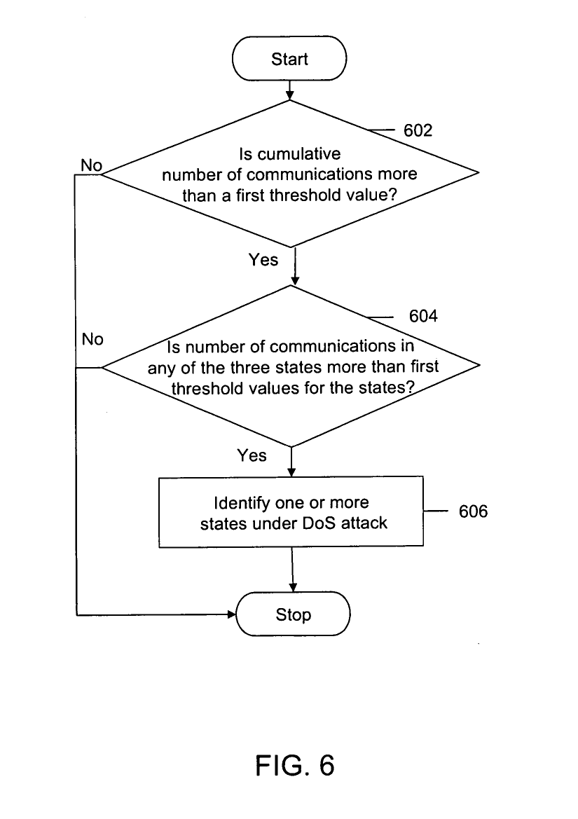

If at 502, the number of communications in one or more states is more than the first set of threshold values, 504 is performed. At 504, a state under a DoS attack is identified. The identification process of the states under a DoS attack is described in detail in conjunction with FIG. 6.

Further, at 506, suspected attackers are detected in the states identified as being under a DoS attack. In various embodiment of the invention, the suspected attackers are detected in a state, based on the time during which communications remain in that state, the number of protocol/control message transfers, the amount of data transfer between various protocol/control message transfers, or the rate of protocol/control message transfers. The process of detection of the suspected attackers is described in detail in conjunction with FIG. 6, FIG. 10, FIG. 11 and FIG. 12.

At 508, it is checked whether the number of communications in one or more states is more than the second set of threshold values. In various embodiments of the invention, the second set of threshold values includes the second threshold values of the number of communications in the individual states, i.e., Tconₜₕ₂, Tctdₜₕ₂ and Tdisₜₕ₂. Further, the second set of threshold values includes a second threshold value of the cumulative number of communications in the three states, Tcurrₜₕ₂. In one embodiment of the invention, the cumulative number of communications in the three states, Tcurr, is compared with Tcurrₜₕ₂. In an alternate embodiment of the invention, the number of communications in connecting, connected, and disconnecting states is compared with the respective second threshold values, i.e., Tconₜₕ₂, Tctdₜₕ₂ and Tdisₜₕ₂.

In various embodiments of the invention, the values selected from the second set of threshold values are greater than the corresponding values selected from the first set of threshold values. For example, Tconₜₕ₂ is greater than Tconₜₕ₁. If at 508, the number of communications in one or more states is less than the second set of threshold values, 502 is repeated. Thereafter, gateway 102 remains in the conservative mode.

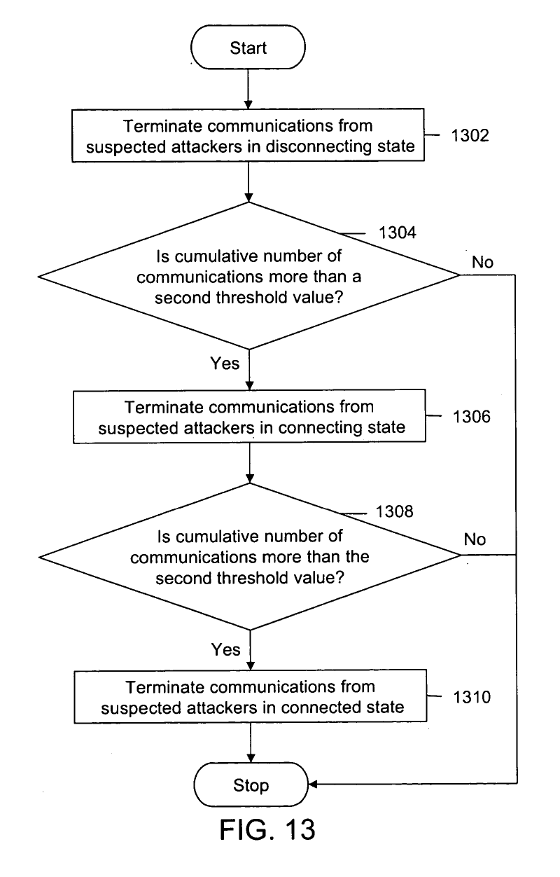

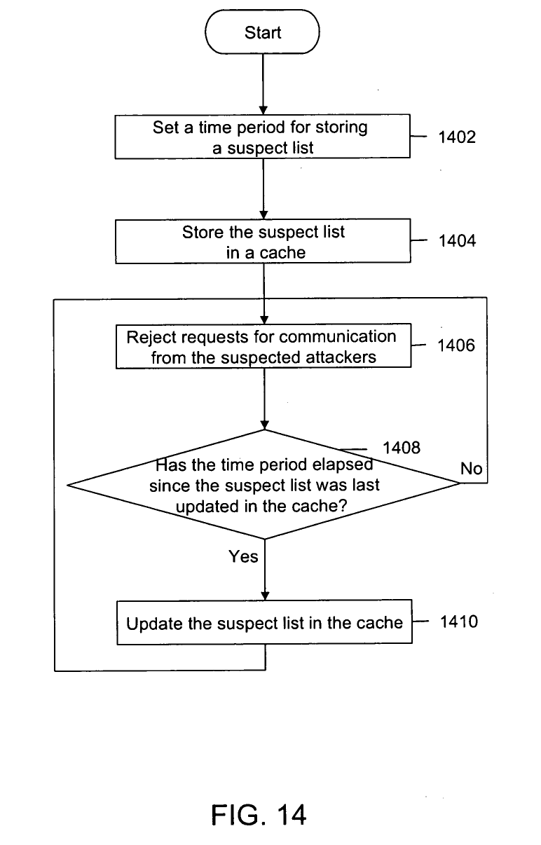

If at 508, the number of communications in one or more states is more than the second set of threshold values, 510 is performed. At 510, countermeasures are initiated against the suspected attackers. In various embodiments of the invention, existing communications from the suspected attackers are terminated in one or more states. The process of the initiation of countermeasures in the panic mode is described in detail in conjunction with FIG. 13 and FIG. 14.

FIG. 6 illustrates a flowchart of a method for identifying one or more states under a DoS attack, in accordance with various embodiments of the invention. At 602, it is checked whether Tcurr is more than Tcurrₜₕ₁. This check is performed to identify a DoS attack. If at 602, Tcurr is more than Tcurrₜₕ₁, 604 is performed. At 604, it is checked whether the number of communications in any of the three states is more than the first threshold values for the states. If at 604, the number of communications in any of the three states is more than the first threshold values for the states, 606 is performed. At 606, one or more states are identified as being under a DoS attack. Thereafter, the states that are identified as being under a DoS attack are monitored, to identify the suspected attackers.

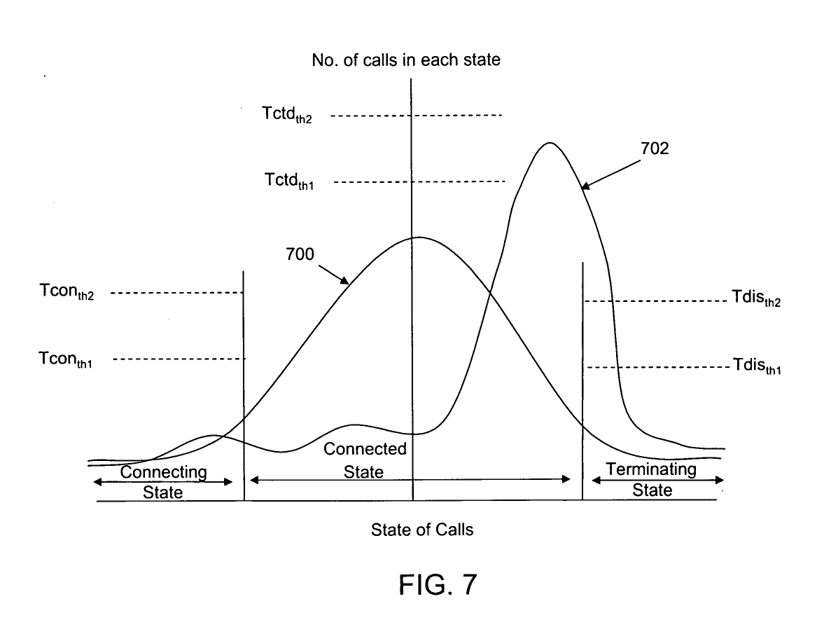

FIG. 7 is an exemplary graph depicting a DoS attack in the disconnecting state, in accordance with various embodiments of the invention. Probability distribution 700 depicts the Poisson distribution of communications in the connecting, connected and disconnecting states. Probability distribution 702 indicates that the majority of the communications are carried out in the disconnecting state.

Identification of a DoS attack in the disconnecting state is illustrated with the help of the following example:
Maximum cumulative communications for the three states, Tₘₐₓ=10000;
First threshold value of cumulative communications, Tcurrₜₕ₁=7500;
Second threshold value of cumulative communications, Tcurrₜₕ₂=9000;
Maximum communications in connecting state, Tconₘₐₓ=2500;
First threshold value of communications in connecting state, Tconₜₕ₁=2000;
Second threshold value of communications in connecting state, Tconₜₕ₂=2225;
Maximum communications in connected state, Tctdₘₐₓ=5000;
First threshold value of communications in connected state, Tctdₜₕ₁=3750;
Second threshold value of communications in connected state, Tconₜₕ₂=4500;
Maximum communications in disconnecting state, Tdisₘₐₓ=2500;
First threshold value of communications in disconnecting state, Tdisₜₕ₁=2000;
Second threshold value of communications in disconnecting state, Tconₜₕ₂=2225;
Current cumulative communications, Tcurr=8250;
Current communications in connecting state, Tcon=1750;
Current communications in connected state, Tctd=2500;
Current communications in disconnecting state, Tdis=4000.

In the example given above, Tcurr exceeds Tcurrₜₕ₁, thereby identifying a DoS attack. Further, the number of communications in the disconnecting state exceeds both Tdisₜₕ₁ and Tdisₜₕ₂. However, the number of communications in the connecting and connected states is much below Tconₜₕ₁ and Tctdₜₕ₁, respectively. Therefore, the detection of suspected attackers is performed for communications in the disconnecting state.

Further, in the example given above, countermeasures against the DoS attack may also be initiated if the cumulative communications are more than Tcurrₜₕ₂.

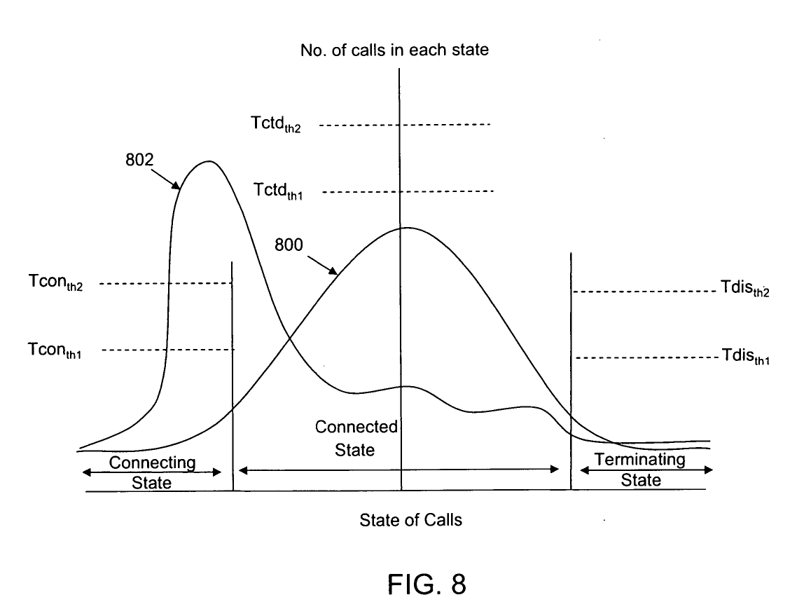

FIG. 8 is an exemplary graph depicting a DoS attack in the connecting state, in accordance with various embodiments of the invention. Probability distribution 800 depicts the Poisson distribution of communications in connecting, connected and disconnecting states. Probability distribution 802 indicates that the majority of the communications are carried out in the connecting state.

The identification of a DoS attack in a connecting state is illustrated with the help of the following example:
Current cumulative communications, Tcurr=8250;
Current communications in connecting state, Tcon=4000;
Current communications in connected state, Tctd=2500;
Current communications in disconnecting state, Tdis=1750.

The threshold values of number of communications are provided in the earlier example in conjunction with FIG. 7. In accordance with the above-stated example, Tcurr exceeds Tcurrₜₕ₁, thereby identifying a DoS attack. Further, the number of communications in the connecting state exceeds both Tconₜₕ₁ and Tconₜₕ₂. However, the number of communications in the disconnecting and the connected states is much below Tdisₜₕ₁ and Tctdₜₕ₁ respectively. Therefore, the detection of suspected attackers is performed for communications in the connecting state.

Further, in the example given above, countermeasures against the DoS attack may also be initiated if the cumulative communications are more than Tcurrₜₕ₂.

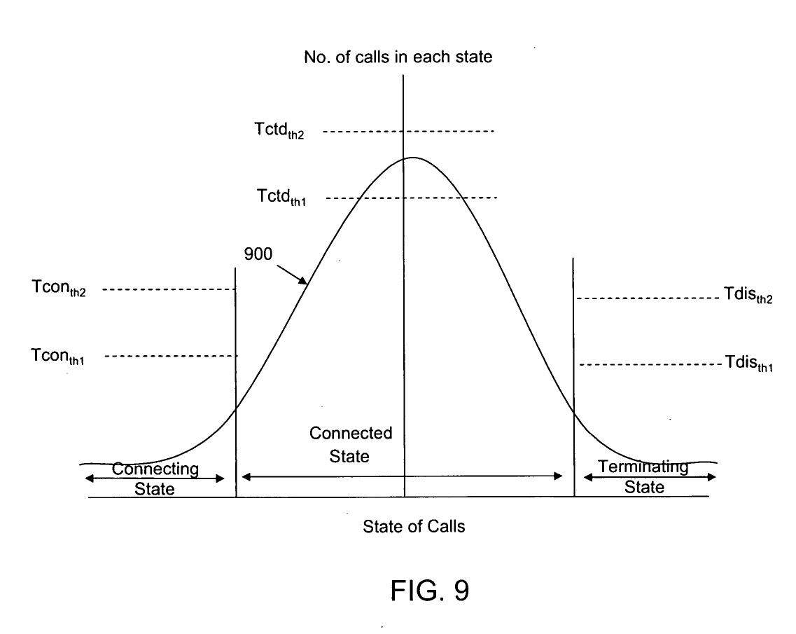

FIG. 9 is an exemplary graph depicting a DoS attack in the connecting state, in accordance with various embodiments of the invention. Probability distribution 900 depicts the Poisson distribution of communications in the connecting, connected and disconnecting states. The number of communications in the connected state exceeds the first threshold value for the connected state, Tctdₜₕ₁.

Identification of a DoS attack in a connected state is illustrated with the help of the following example:
Current cumulative communications, Tcurr=7750;
Current communications in connecting state, Tcon=1750;
Current communications in connected state, Tctd=4250;
Current communications in disconnecting state, Tdis=1750.

The threshold values of number of communications are provided in the earlier example in conjunction with FIG. 7. In accordance with the example stated above, Tcurr exceeds Tcurrₜₕ₁, thereby identifying a DoS attack. Further, the number of communications in the connected state exceeds Tctdₜₕ₁. However, the number of communications in the disconnecting and the connecting states are much below Tdisₜₕ₁and Tconₜₕ₁, respectively. Therefore, the detection of suspected attackers is performed for communications in the connected state.

Further, in the example given above, countermeasures against the DoS attack may also be initiated if the cumulative communications are more than Tcurrₜₕ₂.

FIG. 10 illustrates a flowchart of a method for detecting suspected attackers in the disconnecting state, in accordance with various embodiments of the invention. Each communication in the disconnecting state is provided with an identifier, Ndis. At 1002, a counter is operated to select the first communication in the disconnecting state, i.e., Ndis=1. Different algorithms may be used for selecting the communications in the states, to detect the suspected attackers. At 1004, it is checked whether the time, TNdis, during which Ndis remains in the disconnecting state, is more than a threshold time of a communication in the disconnecting state.

If at 1004, TNdis is less than the threshold time for the disconnecting state, 1006 is performed. At 1006, it is checked whether the number of protocol/control messages transferred in Ndis is more than a threshold value of the number of protocol/control messages transferred for communication in the disconnecting state. If at 1006, the number of protocol/control messages transferred in Ndis is less than the threshold value of the number of protocol/control messages transferred for a communication in the disconnecting state, 1008 is performed. At 1008, the value of Ndis is incremented by one to select the next communication in the disconnecting state. Further at 1010, it is checked whether the value of Ndis is more than the number of communications in the disconnecting state, Tdis. If at 1010, the value of Ndis is less than Tdis, 1004 is repeated.

If at 1006, the number of protocol/control messages transferred in Ndis is more than the threshold value for the number of protocol/control messages transferred for a communication in the disconnecting state, 1012 is performed. At 1012, information related to Ndis is added to a suspect list. In various embodiments of the invention, the source addresses of suspected attackers are stored in the suspect list. Further, 1008 is repeated after 1012. If at 1004, TNdis is more than the threshold time for disconnecting state, 1012 is repeated.

FIG. 11 illustrates a flowchart of a method for detecting suspected attackers in the connecting state, in accordance with various embodiments of the invention. Each communication in the connecting state is provided with an identifier, Ncon. At 1102, a counter is operated to select the first communication in the connecting state, i.e., Ncon=1. At 1104, it is checked whether the time, TNcon, during which Ncon remains in the connecting state, is more than a threshold time for a communication to be in the connecting state. If at 1104, TNcon is less than the threshold time for connecting state, 1106 is performed. At 1106, it is checked whether the number of protocol/control messages transferred in Ncon is more than a threshold value of the number of protocol/control message transfers for a communication in the connecting state. If at 1106, the number of protocol/control messages transferred in Ncon is less than the threshold value of the number of protocol/control message transfers for a communication in the connecting state, 1108 is performed. At 1108, the value of Ncon is incremented by one to select the next communication in the connecting state. Further, at 1110, it is checked whether the value of Ncon is more than number of communications in the connecting state, Tcon. If at 1112, the value of Ncon is less than Tcon, 1104 is repeated.

If at 1106, number of protocol/control messages transferred in Ncon is more than the threshold value of number of protocol/control messages transferred for a communication in the connecting state, 1112 is performed. At 1112, information related to Ncon is added to the suspect list. Further, 1108 is repeated after 1112. If at 1104, TNcon is more than the threshold time for connecting state, 1112 is repeated.

FIG. 12 illustrates a flowchart of a method for detecting suspected attackers in the connected state, in accordance with various embodiments of the invention. Each communication in the connected state is provided with an identifier, Nctd. At 1202, a counter is operated to select the first communication in the connected state, i.e., Nctd=1. At 1204, it is checked whether the rate of protocol/control messages transferred in Nctd is greater than a threshold rate, Rₜₕ. If at 1204, the rate of protocol/control messages transferred in Nctd is less than Rₜₕ, 1206 is performed. At 1206, the value of Nctd is incremented by one, to select the next communication in the connecting state. Further, 1202 is repeated.

If at 1204, the rate of protocol/control messages transferred in Nctd is more than Rₜₕ, 1208 is performed. At 1208, it is checked whether any data is transferred between particular types of protocol/control message transfers in Nctd. If at 1208, data is transferred between particular types of protocol/control messages in Nctd, 1206 is repeated. If at 1208, no data is transferred between particular types of protocol/control messages in Nctd, 1210 is performed. At 1210, information related to Nctd is added to the suspect list. Further, at 1212, it is checked whether the value of Nctd is less than the number of communications in the connected state, Tctd. If at 1212, the value of Nctd is less than Tctd, 1206 is repeated.

In various embodiments of the invention, a suspect list is maintained for suspected attackers in the connecting, connected and disconnecting states. In one embodiment of the invention, separate suspect lists are maintained for the three states. In various embodiments of the invention, a good list for meaningful communications is also maintained, along with the suspect list.

FIG. 13 illustrates a flowchart of a method for initiating countermeasures against the DoS attack, in accordance with various embodiments of the invention. At 1302, communications from the suspected attackers in the disconnecting state are terminated. Information relating to the suspected attackers is retrieved from the suspect list, to terminate communications. At 1304, it is checked whether the cumulative number of communications in the three states, Tcurr, is more than Tcurrₜₕ₂. In other words, it is checked whether gateway 102 is still in the panic mode. If at 1304, Tcurr is less than Tcurrₜₕ₂, countermeasures against the DoS attack are concluded. In other words, the gateway 102 returns to the normal or conservative mode.

If at 1304, Tcurr is more than Tcurrₜₕ₂, 1306 is performed. At 1306, communications by the suspected attackers in the connecting state are terminated. Further, at 1308, it is checked whether Tcurr is still greater than Tcurrₜₕ₂. If at 1308, Tcurr is less than Tcurrₜₕ₂, countermeasures against the DoS attack are concluded. If at 1304, Tcurr is more than Tcurrₜₕ₂, 1310 is performed. At 1310, communications in the connected state from the suspected attackers are terminated.

In accordance with the method described above, existing communications from suspected attackers in one or more states are terminated. In addition to terminating existing communications, future DoS attacks from the suspected attackers may be prevented by rejecting new requests for communication from the suspected attackers. Further details about the rejection of future requests from the suspected attackers are provided in conjunction with FIG.14.

FIG. 14 illustrates a flowchart of a method for preventing a DoS attack from a suspected attacker, in accordance with various embodiments of the invention. At 1402, a time period for storing information related to one or more suspected attackers in a suspect list, is specified. At 1404, the information related to a suspected attacker is stored in the suspect list. In various embodiments of the invention, the information related to the suspected attacker is stored in the suspect list when an attack is identified from the suspected attacker. In various embodiments of the invention, the suspect list is stored in a cache, locally on gateway 102 or in a main memory in network 100. At 1406, requests for communication from the suspected attacker (stored in the cache) are rejected. This is performed to prevent DoS attacks that may be caused by the suspected attacker. In various embodiments of the invention, the requests for communication are rejected when gateway 102 is in the panic mode.

At 1408, it is checked whether the specified time period has elapsed since the information related to the suspected attacker is stored in the suspect list. If the time period has not elapsed, the process of rejection continues at 1406. The time period for storing the information related to a suspected attacker in the suspect list is calculated from the instance when the last attack was identified from the suspected attacker and the related information was stored in the suspect list. If the specified time period has elapsed since the information related to the suspected attacker is stored in the suspect list, 1410 is performed. At 1410, the information related to the suspected attacker is deleted from the suspect list.

In the case of VolP-based communication, DoS attacks in the connected state may be identified through TCS messages, MSD messages, OLC/CLC sequence messages, and the like.

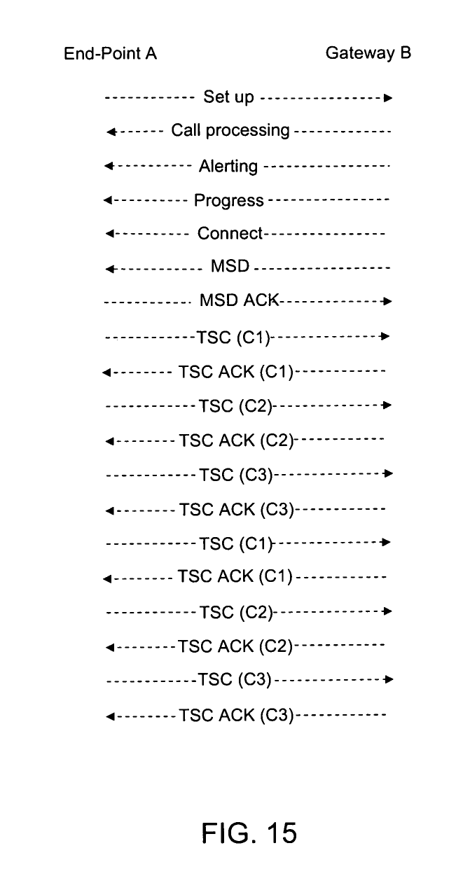

FIG.15 shows an exemplary TCS message transfer, in accordance with various embodiments of the invention. As depicted in FIG. 15, end point A changes its capabilities from C1-C2-C3-C1-C2-C3, and so forth, and gateway B sends acknowledgements for the changed capabilities. These capabilities represent configuration level details of end point A, such as receive and transmit codecs that are supported by end point A. On receiving the acknowledgement corresponding to the changed capabilities, end point A transfers data corresponding to the new capability. However, when gateway B is under a DoS attack by end point A, no data is transferred between end point A and gateway B in between the given set of TCS message transfers for the changed capabilities. This results in misappropriation of the processing power of gateway B. Further, this provides an indication of the DoS attack.

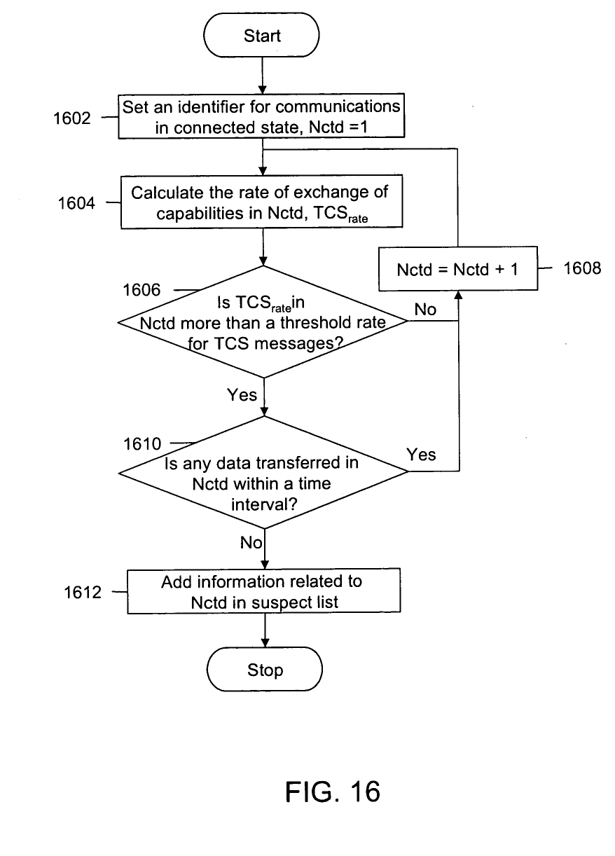

FIG. 16 illustrates a flowchart of a method for detecting a DoS attack caused by TCS messages, in accordance with an exemplary embodiment of the invention. At 1602, the value of Nctd is set as equal to one. At 1604, the rate of exchange of capabilities in Nctd, TCSᵣₐₜₑ, is calculated. At 1606, it is checked whether TCSᵣₐₜₑ is more than a threshold rate of TCS messages. For example, the threshold rate of TCS messages may be specified as the number of TCS messages per second. If at 1606, TCSᵣₐₜₑ is less than the threshold rate of TCS messages, 1608 is performed. At 1608, the value of Nctd is incremented by one. Further, the process of calculating the TCSᵣₐₜₑ for Nctd is repeated at 1604.

If at 1606, TCSᵣₐₜₑ is more than the threshold rate of TCS messages, 1610 is performed. At 1610, it is checked whether any data has been transferred in Nctd in a given duration of time. The data is transferred in between TCS message transfers in Nctd. If at 1610, data has been transferred in the given duration, 1608 is repeated. If at 1610, no data has been transferred in the given duration, 1612 is performed. At 1612, information related to Nctd is added to the suspect list.

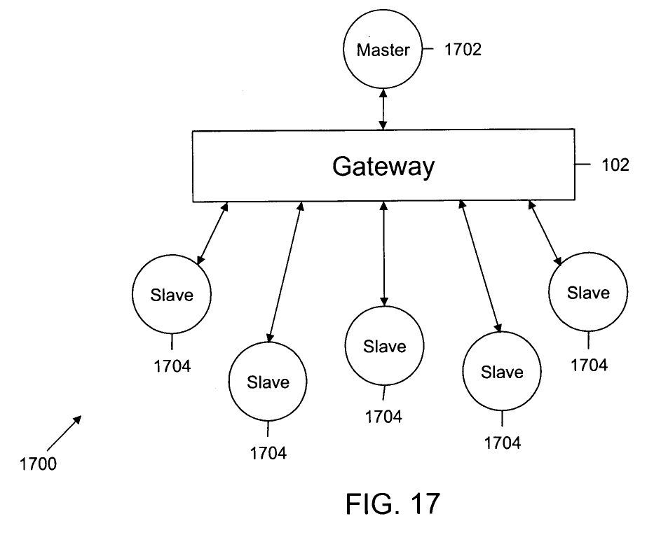

FIG. 17 is a block diagram depicting a master and slave configuration, in accordance with various embodiments of the invention. Network 1700 includes gateway 102, a master 1702, and slaves 1704. In various embodiments of the invention, master 1702 and slaves 1704 are end points 104, hereinafter referred to as end points 1702 and end points 1704. In a conference between multiple end points 104, any one of end points 104 becomes the master, i.e., end point 1702 and the rest of end points 104 remain slaves i.e. end points 1704. End points 104 negotiate with each other through MSD messages, to determine which will be the master in the conference.

Unless end point 1702 decides to leave the conference, or relinquish its role as a master, end points 1704 should remain slaves, i.e., they should not send any MSD messages. However, in the event of an MSD attack, one or more end points 1704 may keep sending MSD messages, to change their status to that of master. These MSD messages misappropriate the processing power of master 1702 (which is under attack from slave terminals).

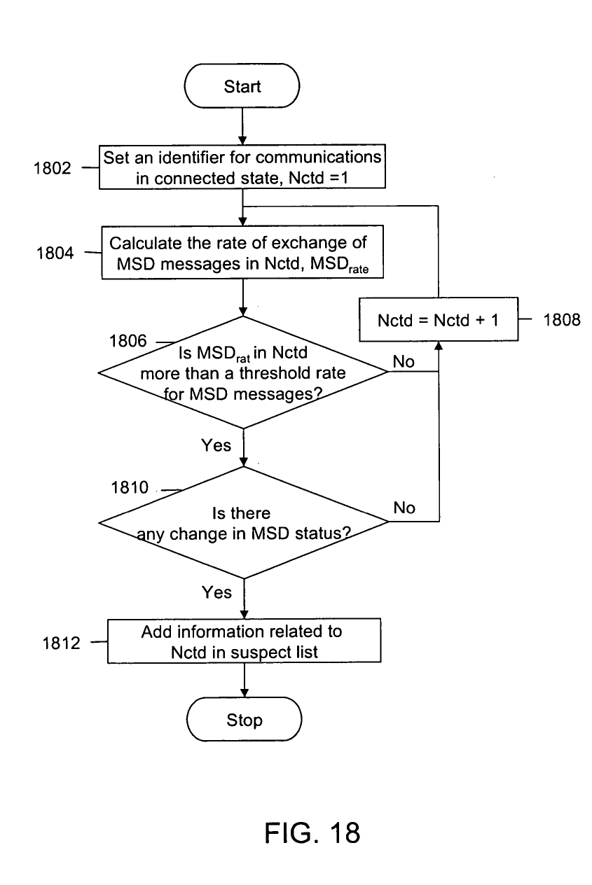

FIG. 18 illustrates a flowchart of a method for detecting a DoS attack caused by MSD messages, in accordance with an exemplary embodiment of the invention. At 1802, the value of Nctd is set as equal to one. At 1804, the rate of exchange of MSD messages in Nctd, MSDᵣₐₜₑ, is calculated. At 1806, it is checked whether MSDᵣₐₜₑ is more than a threshold rate of MSD messages. For example, the threshold rate of MSD messages may be specified as the number of MSD messages per second. If at 1806, MSDᵣₐₜₑ is less than the threshold rate of MSD messages, 1808 is performed. At 1808, the value of Nctd is incremented by one. Further, the process of calculating MSDᵣₐₜₑ for Nctd is repeated at 1804.

If at 1806, MSDᵣₐₜₑ is more than the threshold rate of MSD messages, 1810 is performed. At 1810, it is checked whether there has been any change in the MSD status during a given duration of time. If at 1810, no change has occurred in the MSD status in the given duration, 1812 is performed. At 1812, information related to Nctd is added to the suspect list. If at 1810, a change has occurred in the MSD status in the given duration, 1808 is repeated.

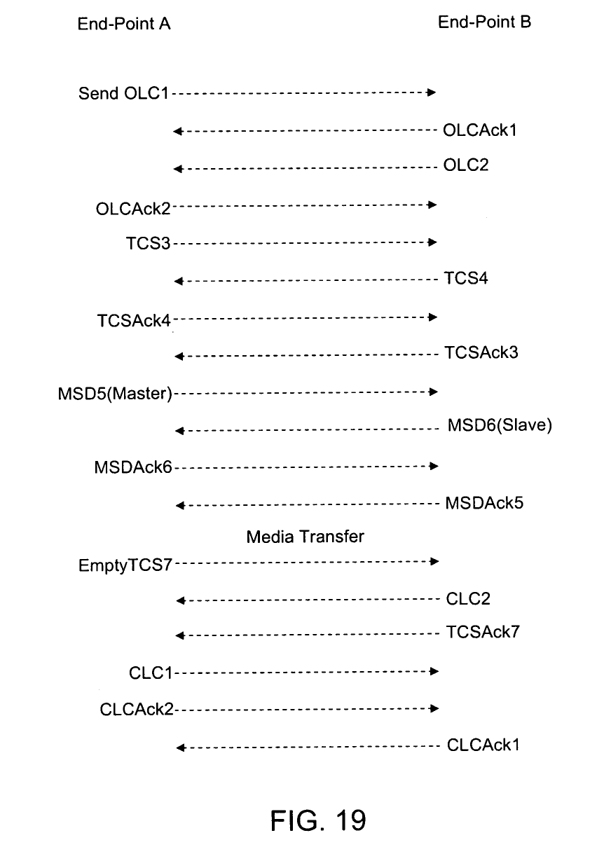

FIG.19 shows an exemplary OLC/CLC sequence message transfer, in accordance with various embodiments of the invention. A set of OLC/CLC messages is exchanged between end point A and end point B, to perform a single redirection of media. The redirection of media is performed through new channels of communication between end point A and end point B. In between the OLC and CLC messages, MSD and TCS messages are exchanged, along with media transfer. In the event of an OLC/CLC attack, an attacker continues to send the set of OLC/CLC messages with intermediate MSD and TCS messages, and pretends to perform redirection. However, no meaningful media are transferred in between the set of OLC/CLC messages. The attacker tries to establish channels through OLC messages, exchange MSD and TCS messages, and close the channels through CLC messages. The attacker may also establish multiple channels, without transferring any media through these channels. This results in the misappropriation of the resources and processing power of gateway 102.

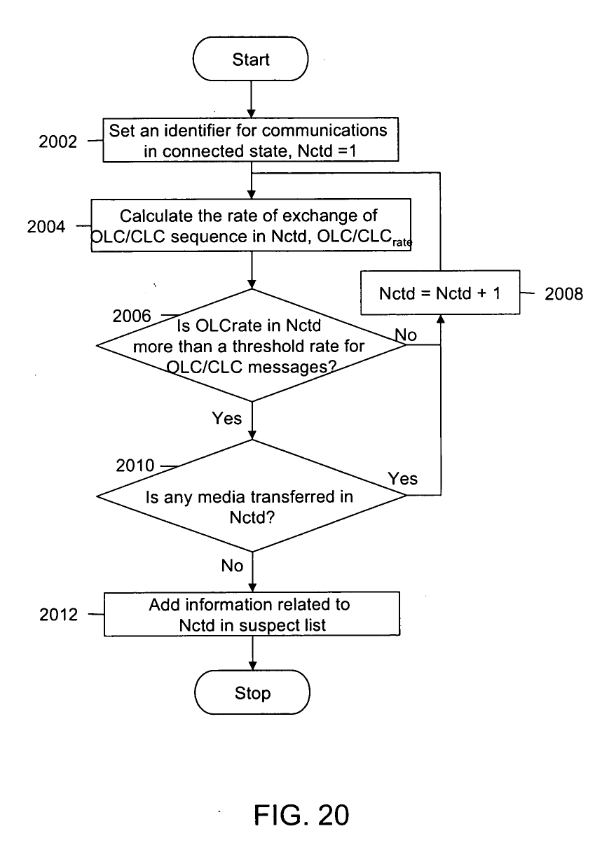

FIG. 20 illustrates a flowchart of a method for detecting a DoS attack caused by OLC/CLC messages, in accordance another exemplary embodiment of the invention. At 2002, the value of Nctd is set as equal to one. At 2004, the rate of exchange of the set of OLC/CLC messages in Nctd, OLC/CLCᵣₐₜₑ, is calculated. At 2006, it is checked whether the OLC/CLCᵣₐₜₑ is more than a threshold rate for OLC/CLC messages. For example, the value of the threshold rate of OLC/CLC messages may be specified as the number of sequence of messages per second. If at 2006, OLC/CLCᵣₐₜₑ in Nctd is less than the threshold rate of OLC/CLC messages, 2008 is performed. At 2008, the value of Nctd is incremented by one. Further, the process of calculating the OLC/CLCᵣₐₜₑ for Nctd is repeated at 2004.

If at 2006, OLC/CLCᵣₐₜₑ is more than the threshold rate of OLC/CLC messages, 2010 is performed. At 2010, it is checked whether any media has been transferred between OLC/CLC sequence message transfers in Nctd in a given duration. If at 2010, no media has been transferred in Nctd in the given duration, 2012 is performed. At 2012, information related to Nctd is added to the suspect list. If at 2010, media has been transferred in Nctd in the given duration, 2008 is repeated.

In one embodiment of the invention, the values of the thresholds are predefined. In another embodiment of the invention, the values of the thresholds are dynamically selected.

In the case of a TCP/IP based communication, SYN attacks are caused in the connecting state, and FIN attacks in the disconnecting state. Further, in the connected state, the attacker may reduce the TCP window size. This results in the misappropriation of the processing power of gateway 102.

A SYN attack in the connecting state can be illustrated with the help of the following example:

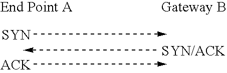

In the example given above, the attacker may leave the communication in a Half Open state by not sending the final acknowledgement, ACK. While sending the SYN packet, the attacker may supply a bogus IP address. Due to this, the attacker does not receive an acknowledgement for the SYN packet, SYN/ACK, and the communication between end point A and gateway B does not take place. This provides an indication of the SYN attack.

A FIN attack in the disconnecting state can be illustrated with the help of the following example:

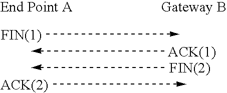

In the example given above, the attacker may leave a communication in a Half Closed state by repeatedly sending FIN(1) packets and not sending the final acknowledgement, ACK(2), to the FIN(2) packet for closing the communication. When ACK(2) is not received by gateway B, it remains in twice Maximum Segment lifetime (2MSL) wait state. However, the attacker may again send the FIN(1) packet, before the 2 MSL wait timer expires. This may force gateway B to go from 2 MSL wait state to the state where it has to send ACK(1) again. In various embodiments of the invention, the FIN attack is identified based on the time during which the final acknowledgement, ACK(2), is not sent to gateway B, i.e., the time when the communication remains in the Half Closed state.

In the connected state, the attacker may specify a reduced TCP window size for transmitting data packets. The size of the TCP window determines the amount of data end points 104 may send through a particular communication, before end points 104 receives an acknowledgment from gateway 102. This may increase the header to data ratio, decreasing the performance of gateway 102. As a result, gateway 102 sends less data packets. In case of an attack, the attacker may keep changing the TCP window size. In some cases, few packets are required to be sent repeatedly due to the change in the TCP window size. This results in decreasing the processing power of gateway 102. This type of DoS attack in the connected state may be identified by comparing the rate of change of the TCP window size with a threshold rate of the change of the TCP window size for data communications.

In an alternate embodiment of the invention, the DoS attacks may be managed by allocating separate resource pools for each state. The resources are used to maintain communication in a state, as well as other information pertaining to communication in the stage. This allocation of resources avoids the misappropriation of the resources of the states that are not under a DoS attack, by the states that are under a Dos attack. In various embodiments of the invention, the resources allocated to the states set the values of various thresholds of communications that can be accepted in the states. Further, the change in the allocation of the resources may alter the values of the thresholds.

Various embodiments of the invention enable the management of DoS attacks, based on two sets of threshold values for the number of communications in one or more states. As a result, when the first set of threshold values is not exceeded, the gateway remains in the normal mode. This reduces the utilization of the processing power of the gateway for monitoring information related to each transmitted packet.

Further, the DoS attack is managed by the gateway, without tracing the source of the DoS attack. In case of a DDoS attack, an attack may appear to originate from different source addresses at different times. However, the gateway traces an attack based on the number of communications in a state. This facilitates identification and prevention of the attacks that appear to originate from different source addresses at different times.

Further, the suspect list containing the source addresses of the suspected attackers is cached for a given time period, to reject future requests from the same addresses. This facilitates the prevention of a DoS attack from the suspected attackers for the given period of time. Further, it facilitates the rejection of a suspected attacker only during the time it attacks the gateway. After this period, the suspected attacker may not attack the gateway.

Various components of the system are implemented on a gateway in the form of a software, a firmware, a hardware or a combinations thereof.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the method of the present invention.

The computer system includes a computer, an input device, a display unit, and the Internet. The computer can incorporate a microprocessor. The microprocessor can be connected to a communication bus. The computer can also include a memory. The memory may include Random Access Memory (RAM) and/or Read Only Memory (ROM). The computer system can further incorporate a storage device. The storage device can include a hard disk drive or a removable storage drive, such as a floppy disk drive and/or an optical disk drive. Storage device can also be other similar device for loading computer programs or other instructions into the computer system.

The computer system executes a set of instructions that are stored in one or more storage elements, in order to process input data. The storage elements may also hold data or other information as required. The storage element may be in the form of an information source or a physical memory element present in the processing machine.

The set of instructions may include various commands that instruct the processing machine to perform specific tasks such as the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

The term logic may include, by way of example, software or hardware and/or combinations of software and hardware.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for managing Denial of Service (DoS) attacks, the method comprising:
identifying one or more states under DoS attack if the number of communications in the one or more states is more than one or more values selected from a first set of threshold values;
detecting one or more suspected attackers in the identified one or more states under DoS attack; and
initiating countermeasures against the DoS attack from the one or more suspected attackers if the number of communications in the one or more states is more than one or more values selected from a second set of threshold values.

2. The method according to claim 1 further comprising storing information relating to the one or more suspected attackers, wherein the information is stored for a defined duration.

3. The method according to claim 1, wherein the one or more states are logical communication states characterised by one or more protocol/control message transfers, the logical communication states being selected from a group consisting of a connecting state, a connected state and a disconnecting state.

4. The method according to claim 1, wherein detecting the one or more suspected attackers comprises segregating one or more suspected attacks from one or more meaningful communications in the identified one or more states under DoS attack.

5. The method according to claim 1, wherein detecting the one or more suspected attackers in a connecting state comprises comparing parameters selected from a group consisting of the time during which one or more communications are in the connecting state and the number of protocol/control message transfers for the one or more communications in the connecting state, to their respective threshold values in the connecting state, the connecting stage being a logical communication state characterised by one or more protocol/control message transfers.

6. The method according to claim 1, wherein detecting the one or more suspected attackers in a connected state comprises comparing parameters selected from a group consisting of the rate of a plurality of protocol/control message transfers, and data transfer between the plurality of protocol/control message transfers, to their respective threshold values in the connected state, the connected stage being a logical communication state characterised by one or more protocol/control message transfers.

7. The method according to claim 1, wherein detecting the one or more suspected attackers in a disconnecting state comprises comparing parameters selected from a group consisting of the time during which one or more communications are in the disconnecting state, and number of protocol/control message transfers for the one or more communications in the disconnecting state, to their respective threshold values in the disconnecting state, the disconnecting stage being a logical communication state characterised by one or more protocol/control message transfers.

8. The method according to claim 1, wherein the one or more values selected from the second set of threshold values are higher than the one or more values selected from the first set of threshold values.

9. The method according to claim 1, wherein initiating countermeasures against the DoS attack from the one or more suspected attackers comprises terminating one or more communications of the one or more suspected attackers in the one or more states.

10. The method according to claim 1, wherein initiating countermeasures against the DoS attack from the one or more suspected attackers comprises terminating one or more communications of the one or more suspected attackers in a disconnecting state, the termination subsequently being followed in a connecting state and a connected state, wherein the disconnecting state, the connecting state and the connected state are logical communication states characterised by one or more protocol/control message transfers.

11. The method according to claim 1, wherein initiating countermeasures against the DoS attack from the one or more suspected attackers comprises rejecting one or more requests for communication from the one or more suspected attackers.

12. The method according to claim 1, wherein the countermeasures against the DoS attack are initiated in the one or more states which are under the DoS attack.

13. The method according to claim 1, wherein the protocol for communication is selected from a group consisting of a telephony protocol, an audiovisual protocol, and an internetworking communication protocol.

14. The method according to claim 1, wherein the protocol for communication is selected from a group consisting of H.323 protocol, Session Initiation Protocol (SIP), and Transmission Control Protocol/Internet Protocol (TCP/IP).

15. A gateway comprising:
an identification module to identify one or more states under Denial of Service (DoS) attack if the number of communications in the one or more states is more than one or more values selected from a first set of threshold values;
a detection module to detect one or more suspected attackers in the identified one or more states under DoS attack; and
a countermeasures module to initiate countermeasures against the DoS attack from the one or more suspected attackers if the number of communications in the one or more states is more than one or more values selected from a second set of threshold values.

16. The gateway according to claim 15, wherein the one or more states are logical communication states characterised by one or more protocol/control message transfers, the logical communication states selected from a group consisting of a connecting state, a connected state and a disconnecting state.

17. The gateway according to claim 15, wherein the detection module comprises a segregation module to segregate one or more suspected attacks from one or more meaningful communications in the identified one or more states under DoS attack.

18. The gateway according to claim 15, wherein the detection module comprises a connecting state module to compare parameters selected from a group consisting of the time during which one or more communications are in the connecting state, and the number of protocol/control message transfers for the one or more communications in the connecting state, to their respective threshold values in the connecting state, the connecting stage being a logical communication state characterised by one or more protocol/control message transfers.

19. The gateway according to claim 15, wherein the detection module comprises a connected state module to compare parameters selected from a group consisting of the rate of a plurality of protocol/control message transfers, and data transfer between the plurality of protocol/control message transfers, to their respective threshold values in the connected state, the connected stage being a logical communication state characterised by one or more protocol/control message transfers.

20. The gateway according to claim 15, wherein the detection module comprises a disconnecting state module to compare parameters selected from a group consisting of the time during which one or more communications are in the disconnecting state, and number of protocol/control message transfers for the one or more communications in the disconnecting state, to their respective threshold values in the disconnecting state, the disconnecting stage being a logical communication state characterised by one or more protocol/control message transfers.

21. The gateway according to claim 15, wherein the countermeasures module comprises a termination module to terminate one or more communications of the one or more suspected attackers in the one or more states.

22. The gateway according to claim 15, wherein the countermeasures module comprises a termination module to terminate one or more communications of the one or more suspected attackers in a disconnecting state, the termination subsequently being followed in a connecting state and a connected state, wherein the disconnecting state, the connecting state and the connected state are logical communication states characterised by one or more protocol/control message transfers.

23. The gateway according to claim 15, wherein the countermeasures module comprises a rejection module to reject one or more requests for communication from the one or more suspected attackers.

24. A computer program product for use with a computer, the computer program product comprising a computer usable medium having a computer readable program code embodied therein for managing Denial of Service (DoS) attacks, the computer readable program code performing:
identifying one or more states under DoS attack if the number of communications in the one or more states is more than one or more values selected from a first set of threshold values;
detecting one or more suspected attackers in the identified one or more states under DoS attack; and
initiating countermeasures against the DoS attack from the one or more suspected attackers if the number of communications in the one or more states is more than one or more values selected from a second set of threshold values.

25. The computer program product according to claim 24, wherein the computer readable program code performing detecting the one or more suspected attackers comprises a computer program code performing segregating one or more suspected attacks from one or more meaningful communications in the identified one or more states under DoS attack.

26. The computer program product according to claim 24, wherein the computer readable program code performing detecting the one or more suspected attackers in a connecting state comprises a computer program code performing comparing parameters selected from a group consisting of the time during which one or more communications are in the connecting state and the number of protocol/control message transfers for the one or more communications in the connecting state, to their respective threshold values in the connecting state, the connecting stage being a logical communication state characterised by one or more protocol/control message transfers.

27. The computer program product according to claim 24, wherein the computer readable program code performing detecting the one or more suspected attackers in a connected state comprises a computer program code performing comparing parameters selected from a group consisting of the rate of a plurality of protocol/control message transfers, and data transfer between the plurality of protocol/control message transfers, to their respective threshold values in the connected state, the connected stage being a logical communication state characterised by one or more protocol/control message transfers.

28. The computer program product according to claim 24, wherein the computer readable program code performing detecting the one or more suspected attackers in a disconnecting state comprises a computer program code performing comparing parameters selected from a group consisting of the time during which one or more communications are in the disconnecting state, and number of protocol/control message transfers for the one or more communications in the disconnecting state, to their respective threshold values in the disconnecting state, the disconnecting stage being a logical communication state characterised by one or more protocol/control message transfers.

29. The computer program product according to claim 24, wherein the computer readable program code performing initiating countermeasures against the DoS attack from the one or more suspected attackers comprises a computer program code performing terminating one or more communications of the one or more suspected attackers in the one or more states.

30. The computer program product according to claim 24, wherein the computer readable program code performing initiating countermeasures against the DoS attack from the one or more suspected attackers comprises a computer program code performing rejecting one or more requests for communication from the one or more suspected attackers.
